(19) United States
(12) Patent Application Publication
(10) Pub. No.: US 2021/0001363 A1
(43) Pub. Date: Jan. 7, 2021

(54) INNOVATIVE METHOD AND SYSTEM FOR COATING

(71) Applicant: Oerlikon Surface Solutions AG, Pfäffikon, Pfäffikon (CH)

(72) Inventors: Simon ABRAHAM, Sargans (CH); Tasso KARSCH, Waiblingen (DE)

(21) Appl. No.: 16/969,545

(22) PCT Filed: Feb. 12, 2019
(86) PCT No.: PCT/EP2019/053445

§ 371 Date: Aug. 12, 2020

Related U.S. Application Data
(60) Provisional application No. 62/629,199, filed on Feb. 12, 2018.

(51) Int. Cl. B05B 13/04; B05B 16/00

(52) U.S. Cl. CPC B05B 13/0442; B05B 16/95; B05B 13/0457

(57) ABSTRACT

A method for through-type coating of a device includes picking up a loaded carrier from a supplying conveyor, conveying the loaded carrier together with a fork-type loader into a coating booth, coupling the device to be coated to a system that rotates the device during coating, and separating the device from its carrier; handing over the unloaded carrier to a fork-type unloader; withdrawing the empty loader, the unloader, and the unloaded carrier out of the booth; closing the booth; rotating and coating the device to be coated; opening the booth; conveying the unloaded carrier into the coating booth; uncoupling the device from the system while joining the device with the carrier; withdrawing the unloader and the loaded carrier out of the booth; and handing over the loaded carrier to a discharging conveyor.

The invention concerns a method for through-type coating of a device that may rotate, preferably rotates, during coating according to the preamble of claim 1, a coating installation for performing such a method according to the preamble of claim 7 and a coating installation system comprising such coating installation according to the preamble of claim 12.

### TECHNICAL BACKGROUND

The known installations for through-type coating have a conveyor that extends through the coating booth, from the outside of the loading opening to the outside of the unloading opening. The conveyor must be protected against overspray or other contamination from coating. For that purpose, usually several movable or fixed masks or covers are used in order to shield the surface of the conveyor from this overspray. The masks or covers often have a rather complicated continue and they rather often leave slots through which the overspray can deposit on the surface of the conveyor, so that a complete shielding is not always guaranteed.

The problem becomes even worse if the devices to be coated have to rotate during coating. In this case the frames rotatably holding and driving the devices to be coated have to be moved along with the devices on the conveyor through the coating booth. That leads to an excessive shielding and cleaning effort.

Contamination of carriers and framework may lead to transfer and deposit of coating material into machine section arranged downstream of the machine structure. Such contamination and transfer reduces the quality of the coating. Another problem is that the air flow is obstructed by the conveyor and mask (or covers) which extends through the coating booth.

### The Underlaying Problem

It is an object of the invention to provide for a method for performing a through-type coating which requires no or less shielding of parts that are not allowed to be coated.

### The Inventive Coating Method

The method described by the independent method claim provides a solution for that issue.

The inventive method is a method for through-type coating of a device that may rotate, preferably rotates, during coating—preferably around itself—in a closed coating booth and that is conveyed to and away from the coating booth by means of a carrier which is holding the device in a defined position. Under rotation similar movements to rotation can be understood as that the device is rotated swiveled or presented in a multi position way during coating. Preferably the device does not only but also rotate.

The method consists of or comprises at least the following steps:

The loaded carrier is picked off from a supplying conveyor. The supplying conveyor is preferably a belt conveyor or chain conveyer or any conveyor designed for to transfer devices sitting on a carrier. The carrier, loaded with at least one and preferably a multiplicity of devices to be coated, is moved together with the forks of a fork-type loader through a loading opening of a painting booth into this painting booth.

Such a device to be coated is normally a holder that holds itself a single or a number of substrates to be coated.

Arrived in the painting booth, the device to be coated is coupled to a system providing the device in appropriate manner during coating, preferably the device is rotated. Synchronously with coupling—or at the latest directly hereinafter—, the device to be coated is separated from its carrier, preferably by lowering the fork-type loader. Advantageously the fork-type loader of the invention comprises a very compact mechanism.

The carrier, which is now unloaded, is preferably lowered further over to the forks of a second fork-type unloader that extends through the unloading opening into the painting booth. In this action the carrier is preferably handed over from the fork-type loader to the fork-type unloader.

With other words, the forks of the loader and of the unloader extend through different openings of the booth into the interior of the booth.

Next, the empty forks of the loader are completely withdrawn out of the booth through the loading opening of the booth. Also, and preferred at least partially at the same time, the forks of the unloader are completely withdrawn out of the booth through the unloading opening of the booth. Over that, the independent actuated compact-loaders integrating the special arrangement of the forks will be able to pull out the one empty carrier off the spray booth while the other one is getting prepared to take over a new carrier with uncoated devices. Preferably an independent working with parallel processes is possible. Preferably the independent working is done in parallel processes.

The loading and the unloading opening of the booth are closed by means of shutters. The device to be coated is already rotating or starts rotating during or after the closing of the shutters. Now, the coating starts. After the coating is done and rotation has come to an end, at least the unloading opening of the booth is opened again.

The unloaded carrier is moved together with the forks of the unloader through an unloading opening of the painting booth into the painting booth. Now the coated device is coupled off from the system that has rotated the device during coating and synchronously or right after the coated device is joined with the carrier so that it can be moved together with the carrier.

The forks of the unloader are withdrawn together with the loaded carrier out of the booth through the unloading opening of the booth and the loaded carrier is handed over to a discharging conveyor.

The inventive method does not require any longer that a conveyor belt or a conveyor chain or any transfer element, such as for example cable conveyor technology, lifting beam conveyor technology, linear pushers etc., needs to be extended through the coating booth during coating. So the complicated shielding of the conveyor against overspray is not necessary anymore and no periodical cleaning of the conveyor from overspray that has deposited on the conveyor despite the masking is necessary anymore. Moreover, there is no necessity anymore that the carrier stays positioned in the coating booth during coating.

An important advantage is that nevertheless, the carriers are transported through the coating booth in order to take up the devices after coating again. That way, it is not necessary anymore to collect and to send back again the carriers in front of the coating booth and it is not necessary anymore to continuously make available “fresh” carriers right after the coating booth. Advantageously it is not required that any part of the conveyor system is placed in the coating booth.

### Preferred Embodiments of the Inventive Method

It is preferred to operate the forks in a way that the forks of the loader and the unloader, coming from opposite sides each, meet and laterally pass (or mesh) each other underneath the carrier for handover of the carrier. Thus, it is very easy to accomplish the handover of the carrier from one fork to the other by means of moving at least the fork of the loader relatively to the other fork of the unloader in vertical direction. Thereby, only one of the forks moves while the other stand still or preferably both forks move in opposite vertical directions.

The carrier is moved by means of the forks across through the coating booth as long as no coating takes place.

Preferably, the method is carried out so that the forks of the loader and of the unloader carry out a synchronous transversal movement during loading and/or unloading of the booth. With other words: In order to save time it is advantageous, for example, if during the withdrawal of the unloader's fork having picked up the carrier and the coated device(s) already the loaders fork having picked up a new carrier and the device(s) to be coated next moves into the coating booth.

Preferably, the coupling of the device to the system rotating the device during coating and the separation of the device from its carrier is accomplished by coupling to the ends of the device and then lowering the carrier. For that purpose the fork actually carrying the carrier moves in vertical downward direction. The uncoupling of the device to the system having rotated the device during coating and the fixing of the device to its carrier for further transportation preferably takes place in opposite direction.

For sake of completeness it has to be noticed that obligatory or preferred features that have been by now expressed in terms of a method can lead to a corresponding physical design of the installation for performing this method.

### The Inventive Coating Installation

Moreover, the invention results in a coating installation according to the first device claim.

The inventive coating installation is physically designed so that it is fit for performing the method as explained before.

The coating installation includes a coating booth with a loading opening and a separate unloading opening. Moreover, the coating installation comprises a rotating unit positioned in the booth. The device to be coated can be coupled to the rotating unit. That way, the device to be coated can rotate during coating, preferably around itself. Moreover the inventive coating installation comprises a fork-type loader with forks that can reach through the loading opening into the booth and a separate fork-type unloader with forks that can reach—in opposite direction—through the unloading opening into the booth.

According to the invention, the forks of the loader and of the unloader are—relative to one another—movable in such a way that an empty carrier can be handed over from the forks of the loader to the forks of the unloader within the interior of the coating booth itself. That way it becomes possible to move a carrier across the coating booth without a conveyor chain or belt being fixedly mounted in the booth for crossing it.

### Preferred Embodiments of the Inventive Installation

Preferably, the loader and the unloader have at least a fork each that is movable back and forth in horizontal direction and that is movable in vertical direction up and down. A very preferred solution is to design the forks in such a way that the arms of the respective fork are positioned laterally beside and below a belt-like or chain-like conveyor so that a carrier positioned by the conveyor above the forks can be lifted off from the conveyor by moving the forks in upward direction or so that a carrier can be deposited on the conveyor by moving the forks in downward direction in preferred embodiment passing the transportation surface of the carrier in that way.

Self expanding fork is part of the complete device providing the features to realize the course to be run for charging and discharging the coating booth with the afore mentioned devices. Integrating such functionality preferably allows to bridge the free span between the booth integrated rotation device and the gates of the booth. Such compact design preferably reduces the impact of machine design for the process to be run. Still getting the fork-loader-system integrated in a small booth protecting the process equipment and substrates is mainly protected against contamination as mentioned above.

Another preferred embodiment provides that the rotating system is designed so, that each device to be coated can be coupled and uncoupled to and from the rotating system by performing nothing else than a vertical movement. For that purpose, it is advantageous if the device to be coated is a spindle with two shaft stubs extending therefrom in opposite directions. A preferred embodiment of the rotating system comprises at least two pairs of rollers. Between the two opposite rollers of each pair a cone-shaped gap is embodied. By means of said cone-shaped gap the rollers of each pair can pick up said shaft stub between each other so that the shaft stub is forced to rotate along with the rollers. The cone-shaped gap can also be described as v-shaped gap. The expression “shaft stub” says nothing about the shaft length. It means a shaft that has one free end while the other end is fixed to the said spindle.

Preferably, the system rotating the device during coating is driven by at least one motor that is positioned outside of the booth. Said motor preferably drives a shaft that extends through a wall of the booth into the booth, whereas the breakthrough is preferably sealed. The end of said shaft protruding into the coating booth normally carries one of said rollers supporting the said shaft stub.

### The Inventive Coating Installation System

Moreover, the invention results in a coating installation according to the second independent device claim.

The according coating installation system comprises a coating installation as explained before and, in addition, a multiplicity of carriers. Each carrier comprises at least two recesses into each of which a shaft stub can be inserted from above so that the spindle—from which the shaft stubs protrude—is held by the carrier, whereas the recesses are positioned and designed that way that the end portion of each shaft stub that is provided for being coupled with the said system rotating the spindle during coating freely protrudes from the corresponding recess in outward direction, so that the end of each shaft stub can be coupled to the rotating system.

Further options for design, further technical effects and further benefits are taught by the following example for an inventive embodiment that is explained in greater detail by means of the figures illustrating this embodiment.

### LIST OF FIGURES

FIG. 1 shows a general overview of a manufacturing chain comprising the inventive installation

FIG. 2 shows a coating booth with an ante chamber upfront of the coating booth and an interconnection chamber behind the coating booth

FIG. 3 demonstrates the principle how the device to be coated is hold by the according carrier and how it can be easily coupled to the rotating system

FIGS. 4 to 14 demonstrate possible steps of the inventive process

### AN EXAMPLE FOR AN INVENTIVE EMBODIMENT

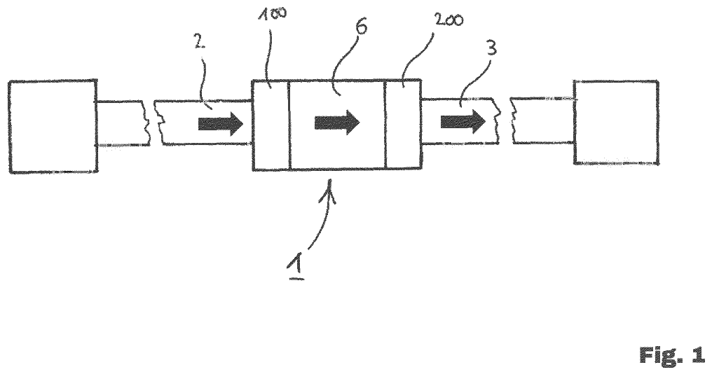

FIG. 1 gives an overview over the general arrangement of the inventive coating installation within a manufacturing chain. The coating installation itself carries reference number 1. Preferably, the coating installation 1 is supplied with devices (being pre-treated in the station shown on left hand side) to be coated by means of supplying conveyor 2. Preferably, the devices already coated will be conveyed away by means of a discharge conveyor 3 may be to the station shown right hand side which could perform a post processing. Said supply conveyor and said discharge conveyor are preferably belt-like or chain-like conveyors. Together with the coating installation they can form a bigger unit which hereinafter is called a coating installation system.

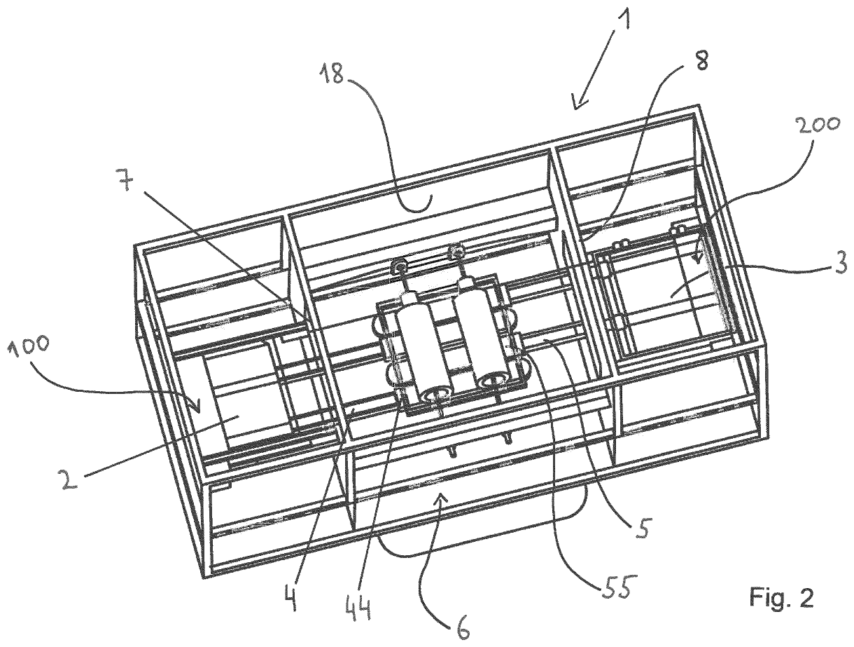

As it can be seen, in FIG. 2 for example the supply conveyor 2 terminates at the loader 4 belonging to the coating installation 1. In the same way, one can see that the discharge conveyor begins at the unloader 5 belonging to the coating installation 1.

FIG. 2 gives a more detailed picture of the inventive coating installation 1. The coating installation 1 comprises a coating booth 6. Within this coating booth, one or more coating robots 9 which for example spray coating and which are not shown in FIG. 2 but in other figures, can be provided. The coating booth 6 normally has a loading opening 7 and, in addition, separated therefrom, an unloading opening 8. Preferably, the loading opening 7 and the unloading opening 8 are positioned at fully opposite sides of the coating booth 6, so that both of said openings are separated by a sidewall of the coating booth 6 that has no relevant openings.

An important aspect is that the coating booth 6 can be completely closed during coating so that no or no relevant amount of solvents, overspray and/or dust or other emissions can escape the coating booth. For that purpose, shutters are provided with which the loading opening 7 and the unloading opening 8 can be closed.

Right in front of the loading opening a loader 4 is positioned. The loader 4 is normally of the fork-lift type. That means loader 4 possesses at least two arms that together form a loading fork which can perform a translatory movement back and forth so that the arms are at least almost completely within the coating booth 6 or completely out of the coating booth. In addition, at least two arms can be moved in vertical direction up and down.

For that purpose, in most cases, the two arms are guided together in a translatory fashion along a common frame, whereas the common frame as a whole can be moved up and down.

As it will be shown in more detail later, it is preferred to design the loading in that way, that one arm can be positioned laterally below the belt or chain of supplying conveyor 2 while the other arm can be positioned laterally below the belt or chain of the supplying conveyor on the other side. Thus, the belt or chain of the supplying conveyor can position a carrier with a device to be coated above the forks of the loader. That way the loader has a possibility to pick up a carrier with a device to be coated from the belt or chain of the supplying conveyor 2.

Right behind the unloading opening 8 an unloader 10 is positioned. The unloader 5 is normally of the fork-lift type, too. All the details that have been described in regard to the design of the loader 4 may apply analogously to the unloader 5. In particular, the at least two arms of the unloader 5 can be moved into a position laterally and below the belt or chain of the discharge conveyor 3 so that a carrier 11 with the coated device can be handed over by the unloader 5 the discharge conveyor by positioning it on the top of the belt or chain.

An important aspect is that the arms of the loader 4 and the arms of the unloaders 5 are positioned with the necessary offset. That means that the arms of the loader 4 and the unloader 5 can pass each other when the arms of the loader move through the loading opening into the paint booth 6 while the arms of the unloader are moved through the unloading opening into the paint booth 6. The situation is shown by FIG. 2. The arms of the loader 4 and of the unloader 5 meet each other below the carrier 11 in interleaved fashion. That way the inventive hand over of the carrier 11 within the booth 6 becomes possible, which will be described in greater detail later.

For the sake of completeness it has to be said that the arms forming together the loading fork 44 and the unloading fork 55 are preferably designed that way that they are telescoping. There is for example the possibility that arms are realised, each by a plunger of a pneumatic cylinder or telescopic rails driven by a electrical motor.

Looking at FIG. 2 again, one sees that the loader 4 is preferably positioned in an own antechamber 100 in front of the coating booth while the unloader 5 is preferably positioned in an own connection chamber 200 behind the coating booth. The antechamber 100 and the connection chamber 200 are preferably designed (for example ventilated) so that solvent, dust or other emissions potentially escaping from the coating booth during loading or unloading can be collected and discharged in a controlled manner.

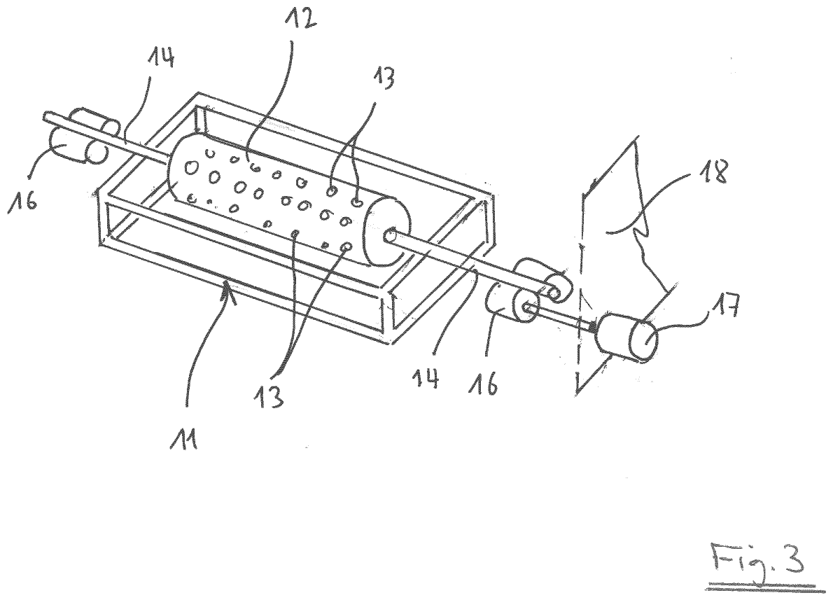

FIG. 3 gives an impression how the system for rotating the device during coating generally works. One can clearly see the carrier 11 which bears the device to be coated 12. The device to be coated 12 here is embodied by a spindle carrying the single substrates 13. The spindle is designed so that from each end face of the spindle shaft stub 14 extends. FIG. 3 shows the situation right before handing over the spindle with the substrates from the carrier 11 to the system for rotating the device which is here formed by the spindle. Right in this moment, each of the shaft stops 14 is still lying in a recess 15 of the carrier 11 so that the spindle is firmly held by the carrier 11. As soon as the carrier 11 will be lowered in the next step each of the shaft stubs 14 will be held between a pair of rollers 16 which are forming here an essential part of the system for rotating.

This visualises that it is rather easy to bring the spindle by means of the carrier 11 in a position where the carrier is not required anymore because the spindle is sole and only held by the rotating system, so that the carrier can be removed out of the coating booth 6.

As roughly sketched by FIG. 3, at least one roller of each pair of rollers is driven, for example by an electric motor 17. The reference number 18 indicates here the sidewall of the coating booth 6. That way, it is made visible that the electric motor 17 is positioned out of the coating booth 6.

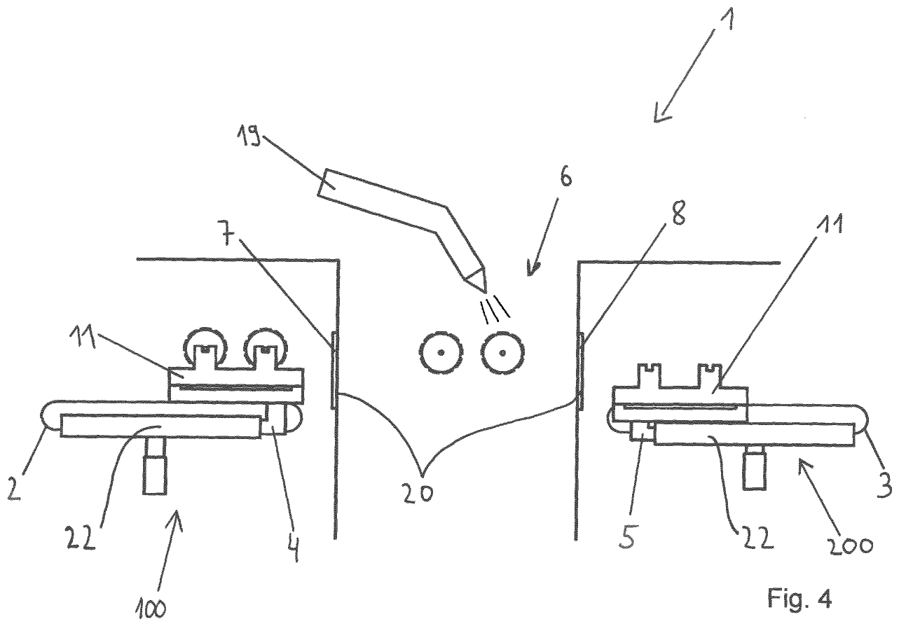

The following sequence of the FIGS. 4 to 14 illustrates in the light of FIGS. 2 and 3 how the inventive system works.

FIG. 4 shows a snapshot during coating. The coating robot 19 sprays the coating onto the devices to be coated 12 which continuously rotate within the coating booth 6. The coating booth 6 is closed by means of the shutters 20. As already explained above an antechamber 100 is provided which accommodates the loader 4. In the same way a connection chamber 200 is provided which accommodates the unloader 5. Such Chambers are only optional.

The loader 4 has already picked up or is about, preferably on train, to pick up a carrier 11 which carries preferably two or more devices to be coated 12 and which are waiting for coating. The unloader 5 holds an empty carrier 11 in wait state.

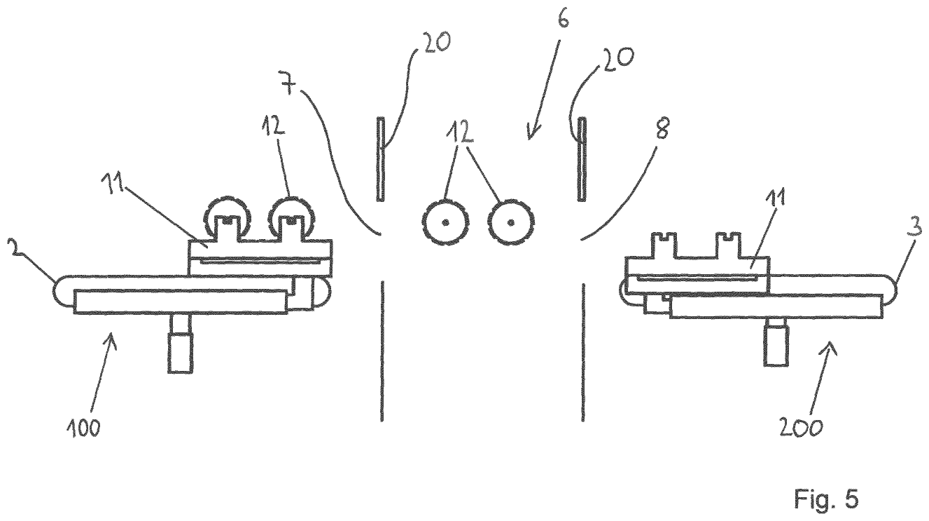

FIG. 5 shows a snapshot of a 2nd step. The coating has been finished now. The rotation of the devices to be coated 12 has preferably already been stopped. The shutters 20 have been opened. The unloader 5 has not yet begun to move its fork 55 carrying the empty carrier 1 through the unloading opening into the coating booth 6.

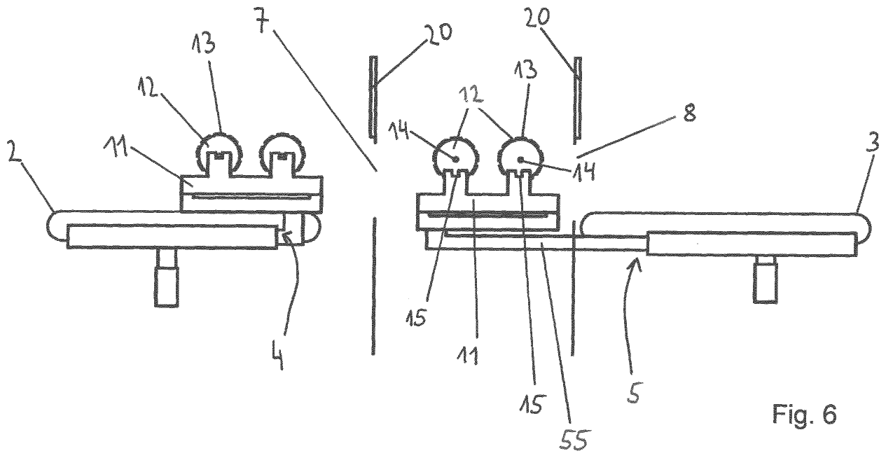

FIG. 6 shows a snapshot of a 3rd step. The unloader has moved its fork 55 carrying the empty carrier 1 through the unloading opening 8 into the coating booth 6 in a position, where the carrier 11 positioned below the devices to be coated 12. The carrier 11 is aligned that way relatively to the devices to be coated 12, that the recesses 15 of the carrier are positioned vertically below the shaft stubs 14 of the devices to be coated. The devices to be coated 12 are still borne by the rotating system not depicted here in detail. By now, loader 4 is taking no action, it is still in wait state.

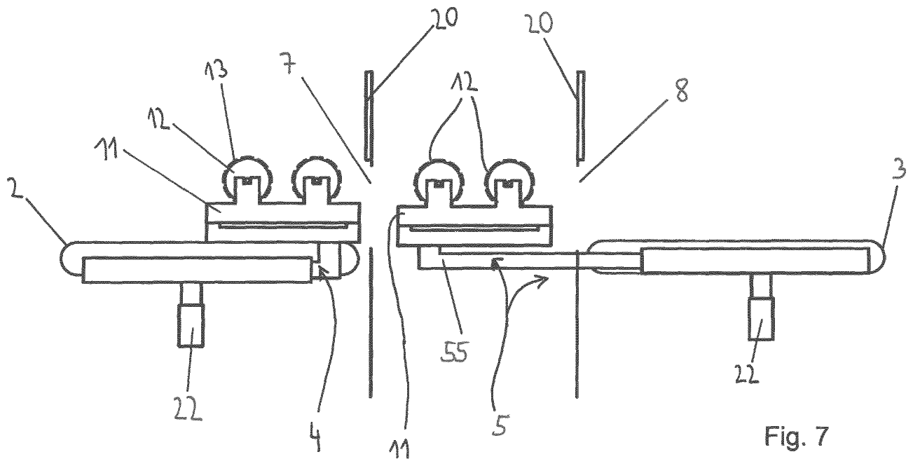

FIG. 7 shows a snapshot of a 4th step. The complete fork 55 of the unloader has been lifted in vertical direction so that each of the shaft stubs 14 has dived into the according recess 15 of the carrier 11. During the ongoing lifting, each shaft stub 14 has that way lifted away from and hung out of the rollers 16, compare at this point FIG. 3 again. Preferably, all of the at least two arms of the unloader 5 are fixed to a common base which can move up and down in vertical direction, for example by means of a vertical pneumatic cylinder 22 or other appropriate linear drive.

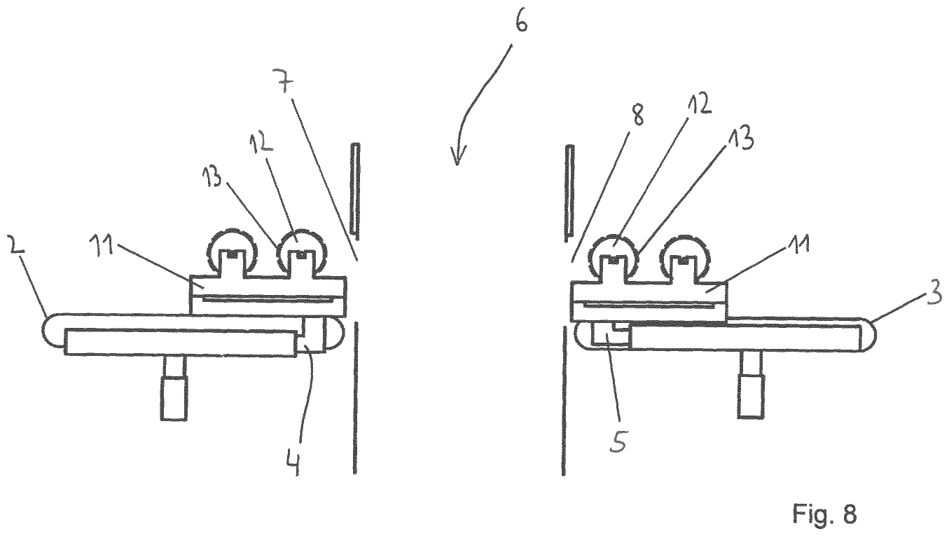

FIG. 8 shows a snapshot of a 5th step. The unloader 5 has withdrawn its fork through the unloading opening 8 out of the coating booth 6, together with the carrier 11 and the devices that have been coated right before and are now hold by the carrier 11.

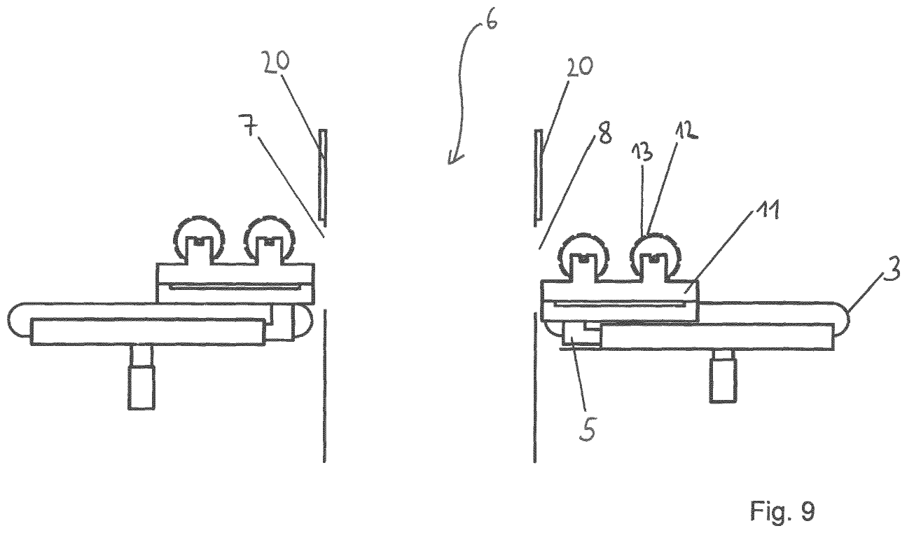

FIG. 9 shows a snapshot of a 6th step. The unloader 5 has lowered its fork so that both arms of the fork a position now laterally beside and below the belt or chain of the discharge conveyor 3. That way the carrier 11 stands now upon the discharge conveyor 3 and can be conveyed away.

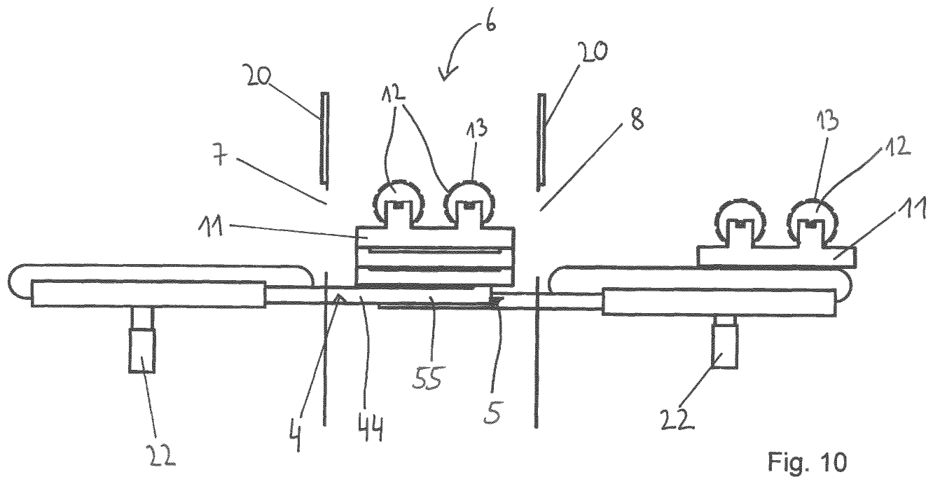

FIG. 10 shows a snapshot of a 7th step. The loader 4 has meanwhile moved its fork 44 along with the next following carrier 11 and the next devices to be coated 12 through the loading opening 7 into the coating chamber 6. Meanwhile, the unloader 5 has been active again, too. The unloader 5 has moved, preferably synchronously to the loader 4, its fork 55 through the unloading opening 8 into the coating booth 6. The arms of the fork 44 and of the fork 55 have partially passed each other so that they are now in the interleaved position that has been explained already in connection with FIG. 2. At the moment, the arms of the fork 44 still hold the carrier 11, since the arms of the fork 44 are positioned above the arms of the fork 55.

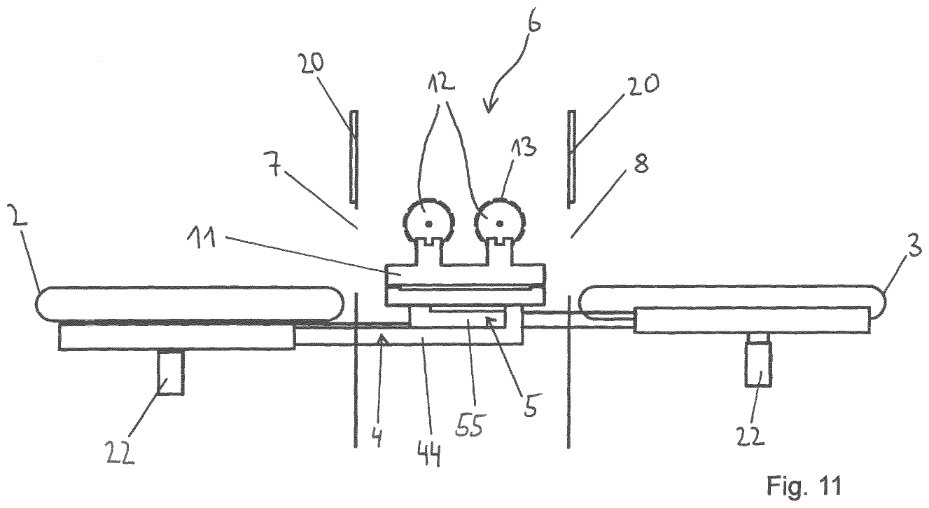

FIG. 11 shows a snapshot of the 8th step. The fork 44 has been lowered in vertical direction. That way, the carrier 11 has been brought out of engagement with the devices to be coated 12 which are now held by the already aforementioned rollers 16 which are not depicted here. Thereby, the fork 44 has been lowered by such an amount, that the carrier 11 now stands on the fork 55 of the unloader 5. That way, a handover of the carrier 11 from the fork 44 to the fork 55 has taken place.

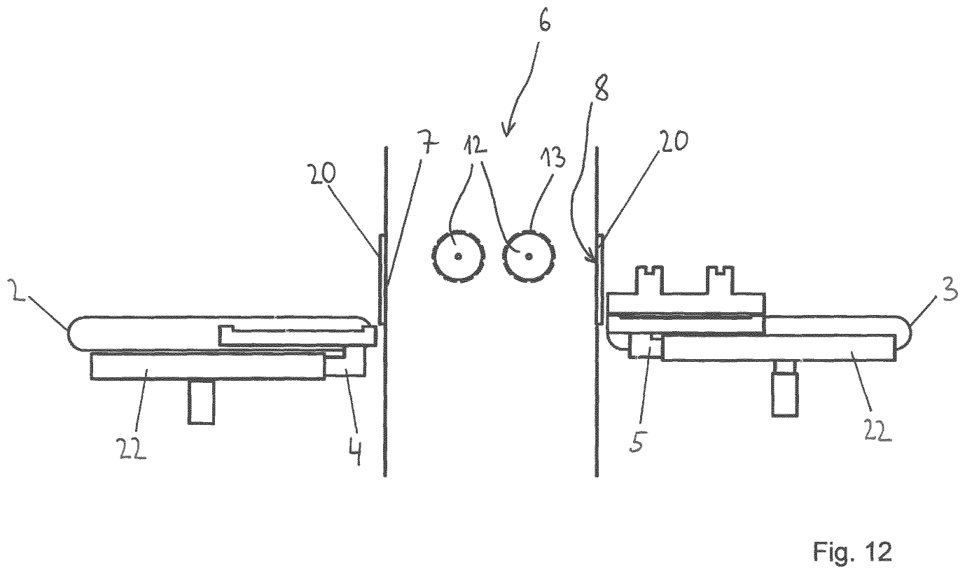

FIG. 12 shows a snapshot of the 9th step as well the fork 44 as the fork 55 have been withdrawn completely from the coating booth 6. Thereby the carrier 11 has been moved along with the fork 55. The fork 55 holds now the carrier 11 in wait state outside of the coating booth 6. Preferably at the same time the fork 44 has moved in a position where its arms are located laterally and below the belt or chain of the supplying conveyor to so that the 44 can pick up another carrier as soon as the supplying conveyor has brought this carrier in a position above the arms of the fork 44.

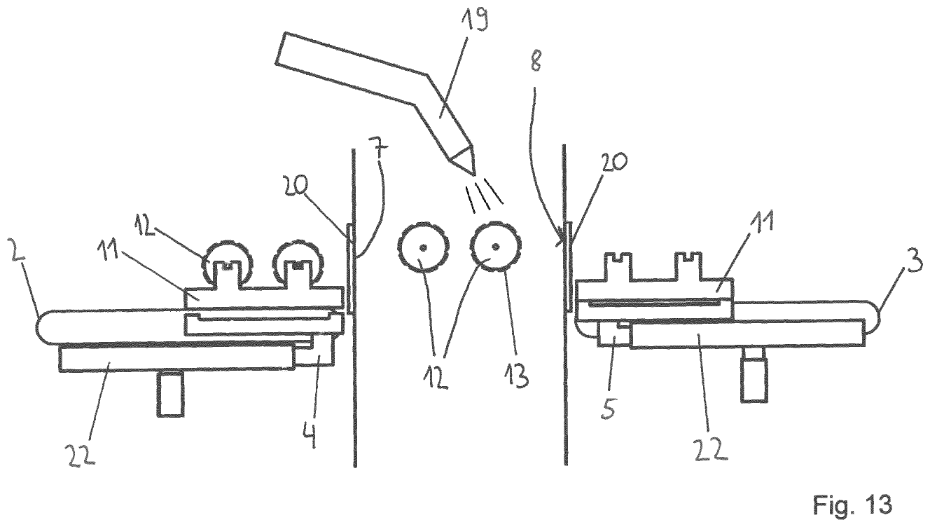

FIG. 13 shows a snapshot of a 10th step. The shutters 20 have closed the loading and unloading opening of the coating booth 6. The coating robot 19 has started to work inside the coating booth 6. The supplying conveyor has positioned a subsequent carrier 11 above the arms of the fork 44.

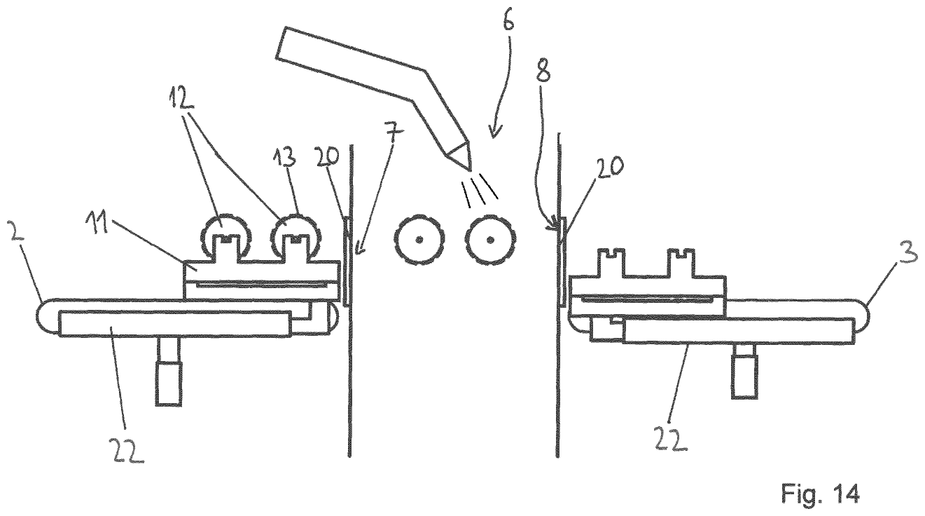

FIG. 14 shows a snapshot of a last step. The arms of the fork 44 have been lifted such an amount that the subsequent carrier 11 has been picked up from the supplying conveyor 2. Now the cycle has been completed and the process can start again with the next step that has already been explained on the basis of FIG. 4.

### LIST OF REFERENCE NUMBERS

1 coating installation
2 supplying conveyor
3 discharge conveyor
4 loader
5 unloader
6 coating booth
7 loading opening
8 unloading opening
9 not assigned
10 not assigned
11 carrier
12 device to be coated
13 substrate
14 shaft stub
15 recess
16 roller
17 electric motor
18 side wall of the coating booth
19 coating robot
20 shutter
21 common base
22 vertical pneumatic cylinder
44 fork of loader
55 fork of unloader
100 ante chamber
200 connection chamber

1. A method for through-type coating of a device that rotates during coating in a closed coating booth and that is conveyed to and away from the coating booth by a carrier holding the device in a defined position, the method comprising the following steps:
picking up the carrier loaded with the device to be coated from a supplying conveyor;
conveying the loaded carrier together with a plurality of forks of a fork-type loader through a loading opening of the coating booth into the coating booth;
coupling the device to be coated to a system that rotates the device during coating, and separating the device from the carrier;
handing over the unloaded carrier to a plurality of forks of a fork-type unloader;
completely withdrawing the empty forks of the loader out of the booth through the loading opening of the booth and completely withdrawing the forks of the unloader together with the unloaded carrier out of the booth through an unloading opening of the booth;
closing the loading opening and the unloading opening of the booth;
rotating and coating the device to be coated;
opening at least the unloading opening of the booth;
conveying the unloaded carrier together with the forks of the unloader through the unloading opening of the coating booth into the coating booth;
uncoupling the device from the system that has rotated the device during coating while joining the device with the carrier;
completely withdrawing the forks of the unloader together with the loaded carrier out of the booth through the unloading opening of the booth; and
handing over the loaded carrier to a discharging conveyor.

2. The method according to claim 1, wherein the forks of the loader and the forks of the unloader laterally pass each other underneath the carrier for handover of the carrier.

3. The method according to claim 2, wherein the forks of the loader are lowered and/or the forks of the unloader are lifted for handover of the carrier.

4. The method according to claim 1, wherein the forks of the loader and the forks of the unloader carry out a synchronous transversal movement during loading and/or unloading of the booth.

5. The method according to claim 1, wherein the coupling of the device to the system that rotates the device during coating and separating the device from its carrier is accomplished by lowering the carrier.

6. The method according to claim 1, wherein the system for rotating the device during coating is driven from outside of the booth.

7. A coating installation for performing the method according to claim 1, wherein the coating installation comprises:
a coating booth with a loading opening and a separate unloading opening;
a rotating unit positioned in the booth to which the device to be coated can be coupled and which can rotate the device during coating; and
a fork-type loader with a plurality of forks that can reach through the loading opening into the booth and a separate a fork-type unloader with a plurality of forks that can reach through the unloading opening into the booth, wherein the forks of the loader and the forks of the unloader are—relative to one another—movable such that an empty carrier can be handed over from the forks of the loader to the forks of the unloader.

8. The coating installation according to claim 7, wherein the loader and the unloader have at least two forks movable back and forth in a horizontal direction and movable in a vertical direction up and down, and the forks can be positioned laterally beside and below a belt-like or chain-like conveyor so that a carrier positioned by the conveyor above the forks can be lifted off from the conveyor by moving the forks in an upward direction or so that a carrier can be deposited on the conveyor by moving the forks in a downward direction.

9. The coating installation according to claim 7, wherein said device that rotates during coating is a spindle carrying a plurality of substrates to be coated, and the spindle is designed such that from each end face of the spindle a shaft stub extends which can be coupled to the system that rotates the device during coating.

10. The coating installation according to claim 9, wherein the rotating system comprises at least two pairs of rollers or clutches which pick up between each other a said shaft stub so that the shaft stub is forced to rotate along with the rollers.

11. The coating installation according to claim 7, wherein the system that rotates the device during coating is driven by at least one motor that is positioned outside of the booth and that drives a shaft that extends through a wall of the booth into the booth, and a breakthrough in the wall is sealed.

12. The coating installation system according to claim 9, wherein the carrier comprises at least two recesses into each of which a said shaft stub can be inserted from above so that the spindle is held by the carrier, and the recesses are positioned and designed such that the end portion of each shaft stub that is provided for being coupled with the said system that rotates the spindle during coating freely protrudes from the corresponding recess in an outward direction.
